(19) United States
(12) Patent Application Publication
(10) Pub. No.: US 2014/0146821 A1
(43) Pub. Date: May 29, 2014

(54) METHOD AND APPARATUS FOR PROTOCOL DATA UNIT SYNCHRONIZATION IN AN IS-IS SYSTEM

(71) Applicant: TELEFONAKTIEBOLAGET L M ERICSSON (PUBL), (US)

(72) Inventors: Wenhu Lu, San Jose, CA (US); Ing-Wher Chen, McLean, VA (US); Thippanna Hongal, Fremont, CA (US)

(73) Assignee: TELEFONAKTIEBOLAGET L M ERICSSON (PUBL), Stockholm (SE)

(21) Appl. No.: 13/841,962

(22) Filed: Mar. 15, 2013

Related U.S. Application Data
(60) Provisional application No. 61/730,778, filed on Nov. 28, 2012.
(60) Provisional application No. 61/730,784, filed on Nov. 28, 2012.
(60) Provisional application No. 61/730,796, filed on Nov. 28, 2012.

(51) Int. Cl. H04L 12/741

(52) U.S. Cl. CPC H04L 45/745
USPC 370/395.31

(57) ABSTRACT

A method and apparatus for effectuating synchronization of local LSPs and remote LSPs in an IS-IS router that includes an inter-process communication module disposed between an active router processor (RP) module and standby router processor (RP) module. Both remote LSP update(s) received by an active IS-IS process and local LSP update(s) generated by the active IS-IS process running on the IS-IS router are synchronized to corresponding database portions associated with a standby IS-IS process of the IS-IS router using respective raw LSPs.

### PRIORITY UNDER 35 U.S.C. §119(e) & 37 C.F.R. §1.78

This nonprovisional application claims priority based upon the following prior United States provisional patent applications entitled: (i) “IS-IS NON STOP ROUTING COMPLETE SEQUENCE NUMBER PROTOCOL (CSNP) DATA UNIT FOR LINK-STATE PROTOCOL (LSP) DATA UNIT RECOVERY AND GRACEFUL RESTART,” Application No. 61/730,778, filed Nov. 28, 2012, in the name(s) of Wenhu Lu, Thippana Hongal and Ing-Wher Chen; (ii) “IS-IS NON-STOP ROUTING (NSR) RAW LINK-STATE PROTOCOL (LSP) DATA UNIT SYNCHRONIZATION,” Application No. 61/730,784, filed Nov. 28, 2012, in the name(s) of Wenhu Lu, Ing-Wher Chen and Thippana Hongal; and (iii) “METHOD AND APPARATUS FOR NON-STOP ROUTING FOR PROCESS RESTART,” Application No. 61/730,796, filed Nov. 28, 2012, in the name(s) of Wenhu Lu, Ing-Wher Chen and Thippana Hongal; each of which is hereby incorporated by reference in its entirety.

### CROSS-REFERENCE TO RELATED APPLICATION(S)

This application discloses subject matter that is related to the subject matter of the following U.S. patent application(s): (i) “METHOD AND APPARATUS FOR PROTOCOL DATA UNIT RECOVERY IN AN IS-IS SYSTEM” (Ericsson Ref. No.: P38850-US2), application Ser. No. ______, filed ______, in the name(s) of Wenhu Lu, Thippana Hongal and Ing-Wher Chen; (ii) “METHOD AND APPARATUS FOR FACILITATING PROCESS RESTART IN AN IS-IS SYSTEM” (Ericsson Ref. No.: P38916-US2), application Ser. No. ______, filed ______, in the name(s) of Wenhu Lu, Ing-Wher Chen and Thippana Hongal; and (iii) “METHOD AND APPARATUS FOR FACILITATING PROCESS RESTART IN A MULTI-INSTANCE IS-IS SYSTEM” (Ericsson Ref. No.: P40160-US1), application Ser. No. ______, filed ______, in the name(s) of Wenhu Lu, Ing-Wher Chen and Thippana Hongal; each of which is hereby incorporated by reference in its entirety.

### FIELD OF THE DISCLOSURE

The present disclosure generally relates to network routing protocol technologies. More particularly, and not by way of any limitation, the present disclosure is directed to a method and apparatus for protocol data unit synchronization in an Intermediate System-Intermediate System (IS-IS) router operable in an IS-IS routing network.

### BACKGROUND

An IS-IS router referred to herein has, among its many functionalities, an ability to generate link state protocol data units (LSPs) to describe the routers and links to which it is connected. The information regarding the connected routers and links may be received from other modules in the router, such as physical ports.

Typically, a standby router module and an active router module may be provided as part of the IS-IS router in order to facilitate the capability referred to as Non Stop Routing (NSR). To support NSR capability, databases used for routing must be synchronized between the standby and active router modules so that when the standby router module becomes active, it has a complete database to function seamlessly.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example IS-IS network environment or domain wherein one or more embodiments of the present patent disclosure may be practiced;

FIG. 2 depicts a block diagram of an IS-IS router system according to an embodiment of the present patent disclosure; and

FIGS. 3-5 depict flowcharts of one or more embodiments pertaining to sequences of events that may occur according to a protocol data unit synchronization mechanism of the present patent disclosure.

### DETAILED DESCRIPTION OF THE DRAWINGS

The present patent disclosure is broadly directed to a method and apparatus for synchronizing LSPs in an IS-IS router having redundancy for purposes of effectuating Non Stop Routing. The present patent disclosure is also directed to associated computer-accessible media, computer programmable products and various software/firmware components relative to the LSP synchronization techniques set forth herein.

In one aspect, an embodiment of a method of synchronizing LSPs in a network element operating as an IS-IS router is disclosed, wherein the IS-IS router may comprise an active route processor (RP) module and a standby route processor (RP) module. The claimed embodiment comprises, inter alia, receiving one or more remote LSP updates from at least one adjacent IS-IS router by an active IS-IS process associated with the active RP module and updating a first remote LSP database portion of a first link state database associated with the active IS-IS process, the updating being effectuated using raw LSPs corresponding to the received one or more remote LSP updates. The claimed method may also include updating a first local LSP database portion of the first link state database based on one or more local LSP updates generated by the active IS-IS process and sending the updated local LSPs to the neighboring routers. A first synchronization process of the claimed method involves synchronizing of the one or more remote LSP updates between the first remote LSP database portion of the first link state database and a second remote LSP database portion of a second link state database associated with a standby IS-IS process on the standby RP module, the first synchronizing being effectuated using raw LSPs corresponding to the one or more remote LSP updates received by the active IS-IS process. A second synchronization process of the claimed method involves synchronizing of the one or more local LSP updates between the first local LSP database portion of the first link state database and a second local LSP database portion of the second link state database associated with the standby IS-IS process, the second synchronizing being effectuated using raw LSPs corresponding to the one or more local LSP updates generated by the active IS-IS process. In another aspect, an embodiment of a non-transitory computer-readable medium containing instructions stored thereon is disclosed. When the stored instructions are executed by a computer system configured to operate as an IS-IS router, the computer system is operable to perform an embodiment of the method set forth above.

In a still further aspect, an embodiment of a network element configured to operate as an IS-IS router is disclosed. The claimed embodiment comprises, inter alia, an active RP module supporting an active IS-IS routing process based on a first link state database, the first link state database including a first local LSP database portion and a first remote LSP database portion, and a standby route processor (RP) module supporting a standby IS-IS process associated with a second link state database, wherein the second link state database includes a second local LSP database portion and a second remote LSP database portion. The claimed network element also includes an inter-process communication module configured to facilitate a first synchronization of one or more remote LSP updates received by the active IS-IS process between the first remote LSP database portion of the first link state database and the second remote LSP database portion of the second link state database, the first synchronization being effectuated using raw LSPs corresponding to the one or more remote LSP updates received by the active IS-IS process, and a second synchronization of one or more local LSP updates generated by the active IS-IS process between the first local LSP database portion of the first link state database and the second local LSP database portion of the second link state database, the second synchronization being effectuated using raw LSPs corresponding to the one or more local LSP updates generated by the active IS-IS process.

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific details. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element (e.g., a router, switch, bridge, etc.) is a piece of networking equipment, including hardware and software that communicatively interconnects other equipment on a network (e.g., other network elements, end stations, etc.). Some network elements may comprise “multiple services network elements” that provide support for multiple networking functions (e.g., routing, bridging, switching, Layer-2 aggregation, session border control, Quality of Service, and/or subscriber management, and the like), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, GPS units, gaming systems, set-top boxes) may access or consume content/services provided over a packet-switched wide area public network such as the Internet via suitable service provider access networks. Subscriber end stations may also access or consume content/services provided on virtual private networks (VPNs) overlaid on (e.g., tunneled through) the Internet. It should be appreciated that one or more embodiments of the present patent disclosure involving IS-IS routing protocol functionality may be implemented in such arrangements wherein the content and/or services are typically provided by one or more end stations (e.g., server end stations) belonging to a service or content provider. Alternatively or additionally, content and/or services may be consumed among the end stations participating in a peer-to-peer service, and may include, for example, public webpages (e.g., free content, online store fronts, search services, etc.), private webpages (e.g., username/password accessed webpages providing email services), and/or corporate networks over VPNs. Typically, subscriber end stations may be coupled (e.g., through customer premise equipment or CPE coupled to an access network (wired or wirelessly)) to edge network elements, which are coupled (e.g., through one or more core network elements) to other edge network elements, which are coupled to other end stations (e.g., server end stations).

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices (e.g., an end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such electronic devices may typically include a set of one or more processors coupled to one or more other components, such as one or more storage devices (non-transitory machine-readable storage media), user input/output devices (e.g., a keyboard, a touch screen, a pointing device, and/or a display), and network connections. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device may be configured to store code and/or data for execution on one or more processors of that electronic device for purposes of implementing one or more techniques of the present disclosure.

By way of example, embodiments of the present patent disclosure will be described below in detail by taking reference to a router network based on the Intermediate System-to-Intermediate System (IS-IS) routing protocol. IS-IS routing protocol, which is standardized according to the ISO/IEC 10589 specification, incorporated by reference herein, is a link-state protocol similar to Open Shortest Path First (OSPF) routing protocol. As is known, a link-state routing protocol is one of the two main classes of routing protocols used in packet-switching networks for communications, the other being the distance-vector routing protocol. Both OSPF and IS-IS are examples of an Interior Gateway Protocol (IGP) that may be used for routing information within a domain or autonomous system (AS). In contrast, an Exterior Gateway Protocol (EGP) may be used for determining network reachability between autonomous systems and makes use of IGPs to resolve routes within an AS.

In a link-state routing protocol based network, each switching node (i.e., nodes or elements that are configured to forward packets, also known as routers) constructs a map of the connectivity of the network, in the form of a graph, showing which nodes are connected to which other nodes. Each node then independently calculates the best paths from that node to every possible destination in the network (e.g., using Dijkstra's algorithm), the collection of which forms the node's routing table or database.

To achieve scalability as well as simplify router design and operation, a hierarchical routing architecture may be utilized in a routing network. For example, a domain or AS—which is a portion of the network that may be under a common administrative authority—may be organized such that one or more areas may be defined within the domain or AS. In general, an area may be a logical entity that is comprised of a set of contiguous routers and the data links that connect them. All routers in the same area exchange information about all the hosts or End Systems (ESs) they can reach. The areas of an AS or domain are connected to form a backbone, wherein the routers have the information how to reach all areas.

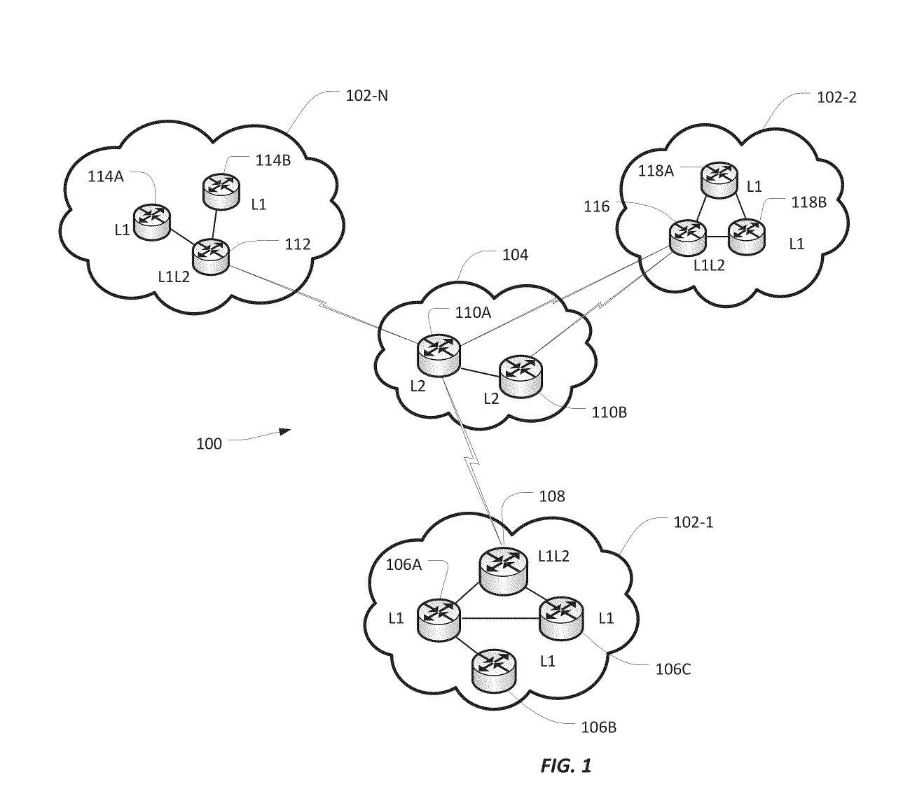

Routers that can communicate within the same area are designated as Level 1 (L1) routers. Routers that form the backbone and have the information to reach other areas are designated as Level 2 (L2) routers. Some routers may be configured to operate as both L1 and L2 routers (L1L2) and may therefore be provided with routing databases specific to both intra-area and inter-area routing. Referring now to the drawings and more particularly to FIG. 1, depicted therein is an example IS-IS network environment or domain 100 comprising a plurality of areas 102-1 to 102-N that are coupled to a backbone 104, wherein an IS-IS router (or, simply an IS router) may be advantageously implemented according to one or more embodiments of the present patent disclosure. By way of illustration, the backbone 104 is comprised of two L2 routers 110A and 110B that are interconnected. Each area is coupled to the backbone 104 via a single L1L2 router within the area. For instance, area 102-1 includes three L1 routers 106A-106C and an L1L2 router 108 that is connected to L2 router 110A of the backbone 104. In similar fashion, area 102-2 includes two L1 routers 118A-118B and an L1L2 router 116 that is connected to both L2 router 110A and L2 router 110B, and area 102-N includes two L1 routers 114A-114B and an L1L2 router 112 that is connected to L2 router 110A.

For purposes of effectuating an operative routing network, each of the IS-IS routers engages in appropriate data exchange processes and maintains a number of databases that can be arranged in any known or heretofore unknown architectures. A unit of data, defined as a protocol data unit (PDU), may be regarded as a packet that is used for exchange of data. Four general types of packets exist, depending on the function of the PDU. A Link State Protocol Data Unit (LSP) is used for distributing link state information relative to the physical links (e.g., broadcast or point-to-point links) supported by the routers of the network. An IS-IS Hello (IIH) PDU is used for establishing and maintaining neighbor relationships (i.e., adjacencies) among the routers of the network, wherein an adjacency refers to a relationship between two IS-IS routers if they can perform a two-way communication with each other. Special PDUs known as Sequence Number PDUs (SNPs) may be used for purposes of link state database synchronization among the IS-IS routers. A Partial Sequence Number PDU (PSNP) is used to acknowledge and request link state information among the routers. A Complete Sequence Number PDU (CSNP) is used to describe a router's complete link state database. Depending on the size of a link state database associated with an IS-IS router, more than one CSNP may be needed to transmit the entire contents of the link state database in certain implementations.

Because of the hierarchical routing architecture of an IS-IS network, such as the network 100 exemplified in FIG. 1, each of the foregoing packets or PDUs can be designated as Level 1 or Level 2 packets and may be used by a router of a particular level for purposes of exchanging data and populating suitable routing databases. A Level 1 (L1) router (e.g., L1 106A in area 102-1) knows the topology of its own area (i.e., it has neighbors only within the same area) and therefore maintains Level 1 databases (e.g., one or more Level 1 link state databases and one or more Level 1 forwarding databases), collectively comprising a routing information database, as well as a Level 1 adjacency database for effectuating intra-area routing. An L1 router may have both L1 and L1/L2 neighbors in its area, however. In similar fashion, a Level 2 (L2) router (e.g., L2 110A) may have neighbors in the same area or other areas and maintains Level 2 databases for effectuating inter-area routing. An L1L2 router (e.g., L1L2 108), on the other hand, maintains separate Level 1 databases (for intra-area routing) as well as Level 2 databases (for inter-area routing).

After the IIH PDUs are exchanged and adjacencies are established in the IS-IS network, LSPs may be transmitted by the routers on all known links or interfaces (i.e., flooding) to exchange network topology information. In general, LSPs have a fixed header and one or more variable length content fields that are encoded using Type, Length and Value (TLV) coding. The fixed header may contain the PDU type/length, the LSP ID and sequence number, checksum, hierarchical level of the LSP (i.e., L1 or L2), among others. The TLV-coded contents may comprise the issuing IS router's area addresses, neighbor IS routers, neighbor ES routers, authentication information, etc.

To support enhanced functionalities such as Non Stop Routing (NSR), Stateful Switch Over (SSO), In-Service Software Upgrades (ISSU), and the like, any of the IS-IS routers exemplified in the IS-IS network 100 of FIG. 1 may be architected with redundancy, e.g., using separate processing hardware platforms or modules (each having one or more processors and associated memory coupled thereto in a suitable bus architecture), whereby an IS-IS routing process involving generation and propagation of the link state information and computation of routes using the link state information (i.e., the control plane) can be provisioned to be executed on the separate hardware platforms. It should be recognized that in some implementations, the individual hardware platforms may be co-located or otherwise integrated into a network element or node. In other implementations, the hardware platforms may be provided as distributed equipment that logically functions as a single network node. Regardless of any specific implementation, when a redundancy architecture having multiple instances of the IS-IS routing process is utilized for an IS router implementation, typically only one of the instances of the IS-IS process executing on the associated hardware platform may be active at any one time, the remaining instances and corresponding hardware platforms being “inactive” or “dormant” (i.e., in a standby mode). Furthermore, the router databases may also be redundantly provisioned or at least logically partitioned such that each standby instance of the IS-IS routing process has a separate database copy associated therewith, which is updated or synchronized based on the database(s) associated with the active IS-IS routing process that typically maintains the most up-to-date or accurate contents (e.g., link state information, forwarding data, adjacency data, etc.).

It should be appreciated that in order to support enhanced functionality such as, e.g., NSR, SSO, etc., the database(s) of a standby IS-IS hardware platform (which may be referred to as a route processor (RP) module) associated with an inactive IS-IS routing process must be maintained as current as possible relative to the database(s) of the active RP module executing the active IS-IS routing process, should it be necessary for any reason that the active IS-IS routing process cease its control plane execution and an inactive IS-IS routing process on the standby RP module take over the control. For example, to provide Non Stop Routing in a failover or in an operator-induced switchover scenario, the link state database of the active RP module (or, more generally an active router) must be accurately synchronized to the database(s) of the standby RP module (or, more generally a standby router) so that when the standby IS-IS router becomes the active IS-IS router, the active IS-IS router has a complete database to function seamlessly.

Those skilled in the art will recognize upon reference hereto that an IS-IS router architected with redundancy may be deployed to include a system of two or more RP modules, at least one of which is in an active mode and the remaining being in a standby mode. Accordingly, references to an “active IS-IS router” may mean an active RP module and references to a “standby IS-IS router” may mean a standby RP module in certain embodiments for purposes of the present patent disclosure.

Regardless of the approach used to synchronize the link state database(s), both local LSPs (i.e., LSPs generated by an RP module of the IS-IS router and remote LSPs (i.e., LSPs originated by other IS-IS routers) received by the IS-IS router must be synchronized between the active and standby RP modules in order to facilitate NSR. Typically, the local LSPs may be generated by an active RP module supporting an active IS-IS process based on the control information, status information, configuration data or updates thereof received from various hardware/software modules associated with the active RP module, including, e.g., line cards, ports, link interfaces, etc. Adding NSR functionality implies that when a standby RP module and the standby IS-IS process supported thereon are activated to become the new active RP module, the new active IS-IS process must also eventually generate LSPs describing the IS-IS router's link states based on the contents of its link state database. Furthermore, if a local LSP generated by the new active RP module is identical to the one generated by the old active RP module of the IS-IS router, that is, it has an identical checksum, then it would be preferable if the sequence number of such a local LSP remains the same and is handled in such a way that the switchover from the old active RP module to the new active RP module of the IS-IS router is transparent to neighboring routers. Clearly, accomplishing such a task requires certain link state data to be on or otherwise available to the standby RP module prior to it becoming the new active RP module of the IS-IS router. Likewise, remote LSPs received from the adjacent routers by the active RP module of the router (which contain the sending/originating router's internal information including its own link state data) are also required to be synchronized to the standby RP module's database.

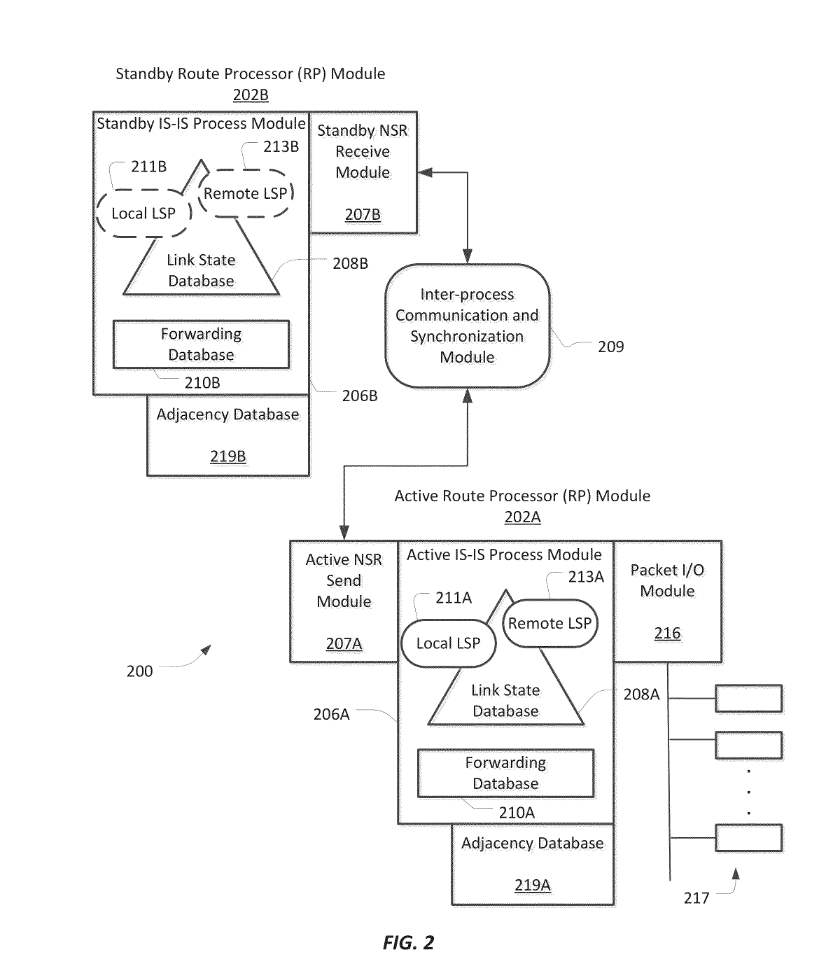

Taking reference to FIG. 2, depicted therein is a logical block diagram of a network element 200 that is capable of operating as an IS-IS router having redundancy wherein both local and remote LSPs may be synchronized between the active and standby platforms according to the teachings of the present patent disclosure. It should be apparent that the network element 200 may be configured to function as a physical router system in an L1, L2 or L1/L2 hierarchy according to the IS-IS specification, and may illustrate a particular implementation of any of the IS-IS routers of the network 100 of FIG. 1 described hereinabove. By way of example, a single active RP module 202A (which may form a computer platform or a portion thereof) supporting an active IS-IS routing process instance or module 206A and a single standby RP module (which may form another computer platform or a portion thereof) 202B supporting an inactive IS-IS routing process instance or module 206B are provided as part of the network element 200. Associated with the existing or current active IS-IS routing process module 206A are the active routing databases, e.g., a first link state database 208A and a first forwarding database 210A, which together form a routing information base (RIB) of the active IS-IS process module 206A. In similar fashion, the existing or current inactive IS-IS routing process module 206B is supported by its databases, e.g., a second link state database 208B and a second forwarding database 210B which form a RIB of the standby IS-IS process module 206B. Each RP module may also be provided with an adjacency database 219A, 219B, although they may comprise a single database with suitable database partitioning in alternative embodiments. A packet input/output (I/O) module 216 is adapted to forward IS-IS packets to appropriate destinations based on subnetwork dependent and/or subnetwork independent functions. Reference numeral 217 generally refers to an assortment of example hardware modules or subsystems (e.g., line cards, ports, link interfaces, etc.) associated with the active RP module 202A that can generate various pieces of control information, configuration data, status information as well as corresponding updates, which may be processed by the active IS-IS process module 206A for updating its link state database as will be described in further detail below. It will be apparent to one skilled in the art that the same or similar hardware modules and subsystems may also be operatively associated with the standby RP module 202B such that when the standby RP module is activated, the subsystems will be under its operational control.

The link data base 208A associated with the active IS-IS process module 206A may be partitioned into separate database portions, e.g., one for storing and maintaining local LSPs and the other for storing and maintaining remote LSPs received from other routers. Reference numeral 211A refers to a first local LSP database portion wherein the locally generated LSPs are stored that may be refreshed or updated based on the configuration data inputs received from the modules 217. Reference numeral 213A refers to a first remote LSP database portion for storing the remote LSPs received from adjacent routers. As these remote LSPs are originated by other routers, which also operate according the IS-IS specification, the remote LSPs contain remote routers' information (link states and other data internal to the remote routers) encoded in the packet format specified by the IS-IS specification. The active IS-IS process module 206A therefore receives the remote LSPs in a raw LSP packet format according to the IS-IS specification, which are stored in the first remote LSP database portion 213A. One skilled in the art will recognize that the raw LSPs received from a remote router are in a format identical to that of the local LSPs generated and flooded to other routers, but contain different information describing the link state data of the originating remote router.

Similar to the active link state database 208A associated with the active IS-IS process module 206A, the standby or second link state database 208B associated with the standby IS-IS process module 206B may also be partitioned into separate local LSP and remote LSP database portions. Reference numerals 211B and 213B refer to example second local LSP and second remote LSP database portions, which are referred to herein as “second” database portions solely to distinguish from the corresponding database portions of the active or first link data base 208A. Although the standby IS-IS process module 206B is in a standby or inactive mode with respect to the control plane of the IS-IS router 200, it may be configured to perform certain limited functions in the “background,” and may therefore receive configuration data inputs from the modules within the router as well. Accordingly, in one example implementation, such data may be used by the standby IS-IS process module 206B to generate, refresh or otherwise update its own local LSPs. Regardless of whether the standby IS-IS process module 206B generates its own local LSPS, the second local LSP and second remote LSP database portions 211B, 213B may be synchronized to the corresponding first local LSP and first remote LSP database portions 211A, 213A, mediated by way of an inter-process communication and synchronization module 209 operatively coupled between the active (i.e., first) and standby (i.e., second) IS-IS process modules 206A, 206B. To facilitate such inter-process communication functionality for effectuating LSP database synchronization, an Active NSR Send module 207A interfaced with the active IS-IS process module 206A may be provided as part of the active RP module 202A and a Standby NSR Receive module 207B interfaced with the standby IS-IS process module 206B may be provided as part of the standby RP module 202B, wherein the inter-process communication module 209 is disposed in a communication relationship with both modules 207A, 207B.

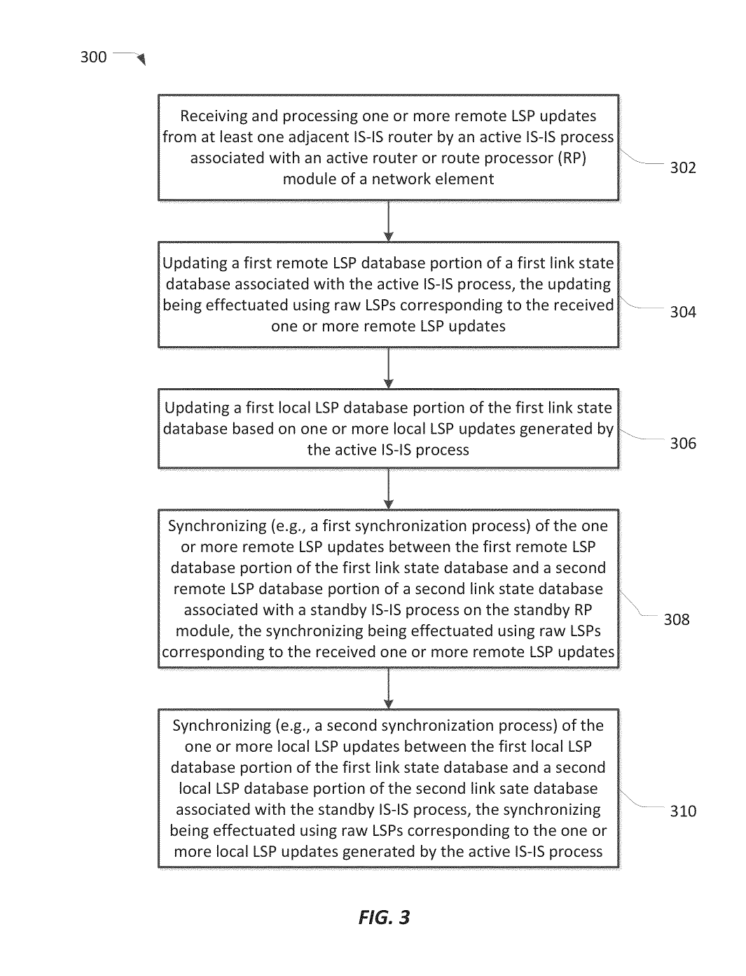

One skilled in the art will recognize that the functionalities relating to NSR capability and facilitating LSP database synchronization may be advantageously grouped into one or more logical blocks in one example implementation, such as modules 209, 207A and 207B set forth above, that may comprise suitable hardware and/or software including storage media having computer-executable instructions. FIGS. 3-5 depict flowcharts of one or more embodiments pertaining to sequences of events that may occur according to an LSP synchronization mechanism of the present patent disclosure, wherein at least a portion of the illustrated acts, blocks, steps, components and functions of the flowcharts may be effectuated by the inter-process communication and synchronization module 209 of FIG. 2. One skilled in the art should appreciate that the order or sequence of the acts, steps, functions, components or blocks illustrated in any of the flowcharts depicted in FIGS. 3-5 may be modified, altered, replaced, customized or otherwise rearranged within a particular flowchart, including deletion or omission of a particular act, step, function, component or block. Moreover, the acts, steps, functions, components or blocks illustrated in a particular flowchart may be inter-mixed or otherwise inter-arranged with the acts, steps, functions, components or blocks illustrated in another flowchart in order to effectuate additional variations, modifications and configurations with respect to one or more LSP synchronization implementations for purposes of practicing the teachings of the present patent disclosure.

Referring in particular to FIG. 3, a process 300 is illustrative of an embodiment of the overall functionality of a Layer-3 network element configured to operate as an IS-IS router system having an active RP module and a standby RP module wherein an LSP synchronization mechanism may be advantageously implemented. As described above in reference to the example network element 200, one of the RP modules may be rendered operable in active mode whereby the IS-IS process instance executing thereon is adapted to receive and process one or more remote LSPs and updates from one or more adjacent IS-IS routers in the domain or network area (block 302). Because the received remote LSPs and updates thereof are in the raw LSP format in accordance with the IS-IS specification, the active IS-IS process instance is configured to update a first remote LSP data portion of a link state database associated therewith, e.g., a first link state database, using the raw LSPs corresponding to the one or more remote LSP updates received from the adjacent routers (block 304). The active IS-IS process module is also operable to receive various pieces of configuration data and control information from one or more hardware and software modules of the example network element, which may be processed into internal data for updating or generating local LSPs by the active IS-IS process. Such local LSPs may be formatted according the IS-IS specification for sending out to the established adjacencies of the network element. Further, a local LSP database portion (e.g., a first LSP database portion) of the link state database associated with the active IS-IS process module is also updated based on the one or more local LSPs and updates thereof generated by the active IS-IS process module (block 306). For purposes of facilitating NSR, two synchronization processes may take place, either separately or together, e.g., as separate threads of a software process, between the active IS-IS process and at least one standby IS-IS process executing on the corresponding hardware platform of the network element (i.e., a standby RP module) with respect to the local and remote LSPs and/or their respective updates handled by the active IS-IS process. A first synchronization process may be configured to synchronize or otherwise update a remote LSP database portion of a link state database associated with the standby IS-IS process instance (e.g., a second link state database) based on the contents of the updated first remote LSP database portion of the first link state database of the active IS-IS process instance, wherein the synchronization is effectuated using the raw LSPs that correspond to the received remote LSPs and/or updates (block 308). Likewise, a second synchronization process may be configured to synchronize or otherwise update a local LSP database portion of the second link state database associated with the standby IS-IS process instance based on the updated first local LSP database portion of the first link state database of the active IS-IS process instance, wherein the synchronization is also effectuated using the raw LSPs that correspond to the locally generated LSPs and/or updates (block 310).

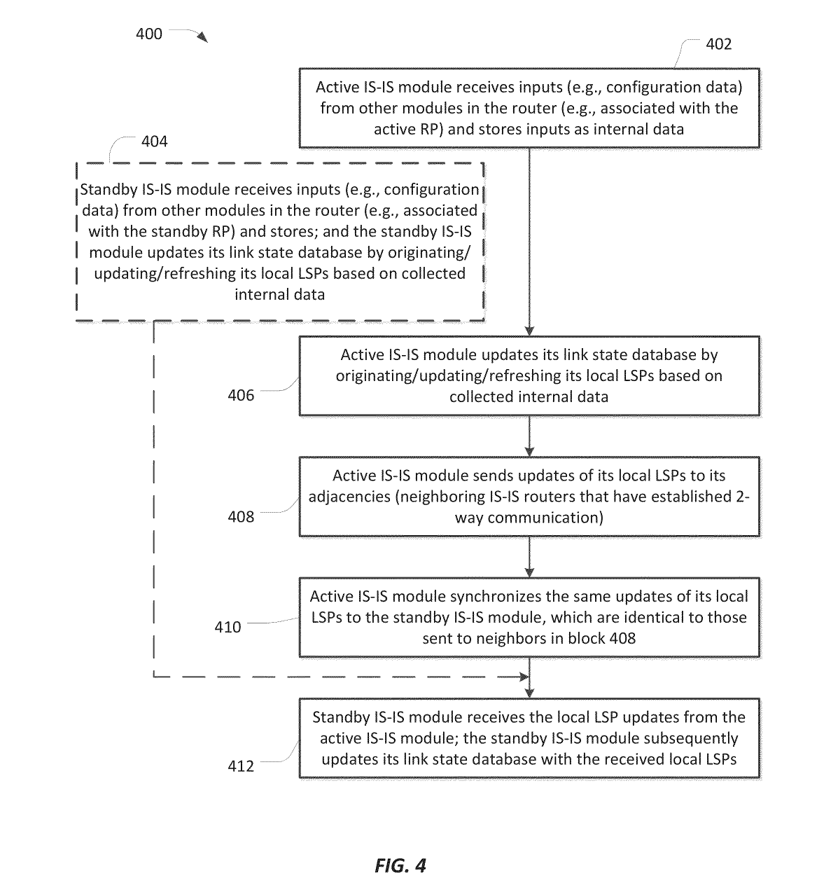

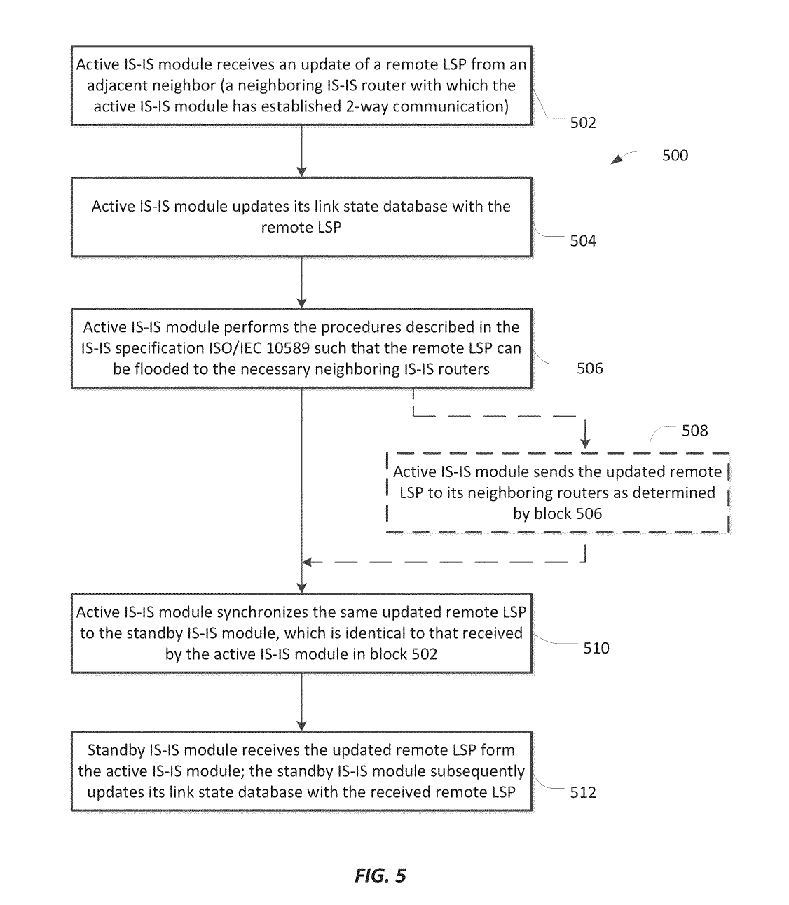

FIGS. 4 and 5 depict flowcharts that illustrate additional details relative to the events of handling local and remote LSPs, respectively, according to example embodiments of the present patent disclosure. Reference numeral 400 in FIG. 4 refers to an LSP synchronization process in an IS-IS network element. When an active IS-IS module receives inputs from one or mode modules of the IS-IS router (e.g., configuration data generated by the line cards, ports, interfaces, circuits, and the like, that are associated with activated IS-IS process(s)), the active IS-IS module stores or otherwise records these inputs, usually in a message format, into its internal data (block 402). Depending on where the inputs are generated, the standby IS-IS module might also optionally receive the same inputs and store them into its own internal data (block 404). It should be apparent that because the standby IS-IS process module is not in full engagement of the control plane of the IS-IS router, and therefore is operatively associated with the remaining modules of the network element only in a minimal fashion, the control/configuration data inputs received by the standby IS-IS process module are typically a reduced subset of the control/configuration data inputs received by the active IS-IS process module. However, more often than not, the standby IS-IS module may not receive such inputs at all in some implementations. In another implementation, the standby IS-IS process may be configured to receive certain control/configuration data associated with the hardware/software modules redundantly associated therewith. Regardless, to the extent the standby IS-IS process receives any control/configuration data inputs, such data may be internally stored and processed for updating, originating, and/or otherwise refreshing a local LSP database portion based on the collected internal data (block 404).

The internal data received and processed with respect to the active IS-IS process module may be utilized in updating its local LSPs and hence the link state database associated therewith (block 406). Subsequently, the active IS-IS process module is required by the IS-IS specification to flood such local LSP updates to neighboring routers with which two-way communication has been established (i.e., adjacencies) (block 408). Further, as described in the foregoing sections, the active IS-IS process module is also required to synchronize the local LSP updates, in the identical format as in block 408, to the standby IS-IS process module in accordance with the teachings of the present patent disclosure (block 410). The standby IS-IS module subsequently updates its link state database with the updated local LSPs once they are received from the active IS-IS process module (block 412).

FIG. 5 illustrates a process 500 regarding the handling and synchronization of remote LSPs in accordance with an embodiment of the present patent disclosure. When an active IS-IS process module receives an updated remote LSP from a neighboring router (block 502), the active IS-IS updates its link state database or a portion thereof with the updated remote LSP (block 504). Based on the IS-IS specification, the active IS-IS process module also determines to which adjacent neighbors to flood the updated remote LSP on all its links/interfaces including point-to-point and broadcast circuits (block 506). Depending on the outcome of block 506, the remote LSP might subsequently be flooded to the necessary neighboring IS-IS routers (block 508). Further, the active IS-IS process module is configured to synchronize the updated remote LSP, in the same format as received, to the standby IS-IS module (block 510). Once the updated remote LSP is received, the standby IS-IS process module updates its link state database or a suitable portion thereof based on the received remote LSP (block 512).

Those skilled in the art will recognize that the embodiments of the present disclosure can advantageously reduce the software code necessary for database synchronization in conventional router implementations because they typically involve two separate approaches for synchronizing local LSPs and remote LSPs between the redundant platforms. In other words, two sets of significantly different code are created and maintained in order to synchronize a link state database of the conventional IS-IS router, thereby increasing the amount of time and complexity needed to process the data. In the example embodiments of the present disclosure, on the other hand, the synchronization code is consistent and/or substantially same for synchronizing both local and remote LSPs between the platforms, resulting in a code that may be reduced as much as by half. Accordingly, the response time of the new activated IS-IS process module of a router undergoing the switchover may be significantly improved because using the raw LSP packets means that routes can be calculated immediately. As a consequence, inter-router database exchange can also occur immediately such that any detrimental effects and associated routing instabilities caused by route removal and insertion in a network domain can be mitigated. Furthermore, having the standby IS-IS process module maintain internal configuration/status control information sent by the active IS-IS process can be problematic in cases where the standby IS-IS process module obtains the same internal information from other standby components. In such cases, the only viable approach in conventional implementations is generally to abandon one copy of the information, resulting in unnecessary and duplicative work, which is alleviated and/or obviated by the example embodiments of the present patent disclosure.

It should be appreciated that when a standby IS-IS process of the router becomes a newly activated IS-IS process because of a switchover (e.g., including a failover condition), the newly activated IS-IS process has both the local and the remote LSPs that were sent by the previous active IS-IS process. Additionally, the newly activated IS-IS will also receive data from other newly activated modules pursuant to the switchover. In one implementation, when the router stabilizes or when a pre-defined checkpoint occurs, the newly activated IS-IS process may validate the synchronized local LSP with its internal data by attempting to generate a new copy of the local LSP (i.e., a new local LSP copy) using its internal data and comparing the checksums of the two copies of the local LSP. If the checksums are identical, then the newly activated IS-IS process determines that the synchronized local LSP is still current and valid. Consequently, the local LSP is not updated unnecessarily and the synchronized local LSP may be retained for use by the IS-IS router. As a further variation in this scenario, the new local LSP may be discarded by the newly activated IS-IS process since it is not needed. On the other hand, if the checksums do not match, then the newly activated IS-IS process determines that the synchronized local LSP needs to be updated and flooded to its adjacent neighbors.

In the foregoing Detailed Description, functionalities of the various elements including components/blocks labeled or described as “module” or “process” or “processor” or “controller” or “computer” may be provided through the use of dedicated hardware as well as hardware capable of executing stored or preconfigured software. When provided by a processor, the functions may be provided by a single dedicated processor, by a single shared processor, or by a plurality of individual processors, some of which may be shared or distributed. Moreover, a “processor” or “controller” may include, without limitation, digital signal processor (DSP) hardware, ASIC hardware, read only memory (ROM), random access memory (RAM), and/or other storage media. In a further variation, the NSR and LSP database synchronization functionality set forth in the foregoing embodiments may be downloaded, uploaded, or otherwise imparted to an existing IS-IS router that does not already have a dedicated module (such as, e.g., the inter-process communication/synchronization module 209) so as to enhance its performance.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A method of synchronizing Link State Protocol Data Units (LSPs) in a network element operating as an Intermediate System-to-Intermediate System (IS-IS) router having an active route processor (RP) module and a standby route processor (RP) module, the method comprising:
receiving one or more remote LSP updates from at least one adjacent IS-IS router by an active IS-IS process associated with the active RP module;
updating a first remote LSP database portion of a first link state database associated with the active IS-IS process, the updating being effectuated using raw LSPs corresponding to the received one or more remote LSP updates;
updating a first local LSP database portion of the first link state database based on one or more local LSP updates generated by the active IS-IS process;
a first synchronizing of the one or more remote LSP updates between the first remote LSP database portion of the first link state database and a second remote LSP database portion of a second link state database associated with a standby IS-IS process on the standby RP module, the first synchronizing being effectuated using raw LSPs corresponding to the one or more remote LSP updates received by the active IS-IS process; and
a second synchronizing of the one or more local LSP updates between the first local LSP database portion of the first link state database and a second local LSP database portion of the second link state database associated with the standby IS-IS process, the second synchronizing being effectuated using raw LSPs corresponding to the one or more local LSP updates generated by the active IS-IS process.

2. The method as recited in claim 1, wherein the one or more local LSP updates are generated by the active IS-IS process responsive to configuration data inputs provided by one or more sub-systems operating in association with the active IS-IS process.

3. The method as recited in claim 1, wherein the one or more local LSP updates generated by the active IS-IS process are flooded to each adjacent IS-IS router coupled to the network element.

4. The method as recited in claim 3, wherein the one or more local LSP updates flooded to each adjacent IS-IS router by the active IS-IS process are based on the raw LSPs used by the active IS-IS process for updating the first local LSP database portion of the first link state database and for synchronizing the one or more local LSP updates with the second local LSP database portion of the second link state database.

5. The method as recited in claim 1, further comprising:
generating one or more local LSP updates by the standby IS-IS process responsive to configuration data inputs provided by one or more sub-systems operating in association with the standby IS-IS process; and
updating the second local LSP database portion of the second link state database based on the one or more local LSP updates generated by the standby IS-IS process.

6. The method as recited in claim 1, wherein the one or more remote LSP updates received by the active IS-IS process are processed for transmission to each adjacent IS-IS router coupled to the network element, excluding the at least one adjacent IS-IS router that provided the one or more remote LSP updates to the network element.

7. The method as recited in claim 1, wherein the first link state database associated with the active IS-IS process and the second link state base associated with the standby IS-IS process each comprises a Level 1 (L1) link state database.

8. The method as recited in claim 1, wherein the first link state database associated with the active IS-IS process and the second link state base associated with the standby IS-IS process each comprises a Level 2 (L2) link state database.

9. The method as recited in claim 1, further comprising:
activating the standby IS-IS process as a new active IS-IS process pursuant to a switchover condition;
validating a synchronized local LSP of the second local LSP database portion of the second link state database based on (i) generating a new local LSP copy using internal data collected by the new active IS-IS process, (ii) generating a checksum for the synchronized local LSP and a checksum for the new local LSP copy, and (iii) comparing the checksums of the synchronized local LSP and the new local LSP copy; and
if the checksums are not identical, updating the synchronized local LSP and flooding the updated synchronized local LSP to each adjacent IS-IS router coupled to the network element.

10. The method as recited in claim 9, further comprising:
if the checksums are identical, discarding the new local LSP copy and retaining the synchronized local LSP for use by the network element.

11. A network element configured to operate as an Intermediate System-to-Intermediate System (IS-IS) router, comprising:
an active route processor (RP) module supporting an active IS-IS routing process based on a first link state database, the first link state database including a first local Link State Protocol Data Unit database portion and a first remote LSP database portion;
a standby route processor (RP) module supporting a standby IS-IS process associated with a second link state database, the second link state database including a second local LSP database portion and a second remote LSP database portion; and
an inter-process communication module configured to facilitate a first synchronization of one or more remote LSP updates received by the active IS-IS process between the first remote LSP database portion of the first link state database and the second remote LSP database portion of the second link state database, the first synchronization being effectuated using raw LSPs corresponding to the one or more remote LSP updates received by the active IS-IS process, and a second synchronization of one or more local LSP updates generated by the active IS-IS process between the first local LSP database portion of the first link state database and the second local LSP database portion of the second link state database, the second synchronization being effectuated using raw LSPs corresponding to the one or more local LSP updates generated by the active IS-IS process.

12. The network element as recited in claim 11, wherein the first link state database associated with the active IS-IS process and the second link state base associated with the standby IS-IS process each comprises a Level 1 (L1) link state database.

13. The network element as recited in claim 11, wherein the first link state database associated with the active IS-IS process and the second link state base associated with the standby IS-IS process each comprises a Level 2 (L2) link state database.

14. The network element as recited in claim 11, wherein the active IS-IS process is configured to generate the one or more local LSP updates responsive to configuration data inputs provided by one or more sub-systems operating in association with the active IS-IS process.

15. The network element as recited in claim 11, wherein the active IS-IS process is configured to transmit the one or more local LSP updates to each adjacent IS-IS router coupled to the network element.

16. The network element as recited in claim 11, wherein the standby IS-IS process is configured to generate one or more local LSP updates responsive to configuration data inputs provided by one or more sub-systems operating in association with the standby IS-IS process and to update the second local LSP database portion of the second link state database based on the one or more local LSP updates generated by the standby IS-IS process.

17. A non-transitory computer-readable medium containing instructions stored thereon which, when executed by a computer system configured to operate as an Intermediate System-to-Intermediate System (IS-IS) router having an active route processor (RP) module and a standby route processor (RP) module, perform the acts:
processing one or more remote Link State Protocol Data Unit (LSP) updates received from at least one adjacent IS-IS router by an active IS-IS process associated with the active RP module;
updating a first remote LSP database portion of a first link state database associated with the active IS-IS process, the updating being effectuated using raw LSPs corresponding to the received one or more remote LSP updates;
updating a first local LSP database portion of the first link state database based on one or more local LSP updates generated by the active IS-IS process;
a first synchronizing of the one or more remote LSP updates between the first remote LSP database portion of the first link state database and a second remote LSP database portion of a second link state database associated with a standby IS-IS process on the standby RP module, the first synchronizing being effectuated using raw LSPs corresponding to the one or more remote LSP updates received by the active IS-IS process; and
a second synchronizing of the one or more local LSP updates between the first local LSP database portion of the first link state database and a second local LSP database portion of the second link state database associated with the standby IS-IS process, the second synchronizing being effectuated using raw LSPs corresponding to the one or more local LSP updates generated by the active IS-IS process.

18. The non-transitory computer-readable medium as recited in claim 17, wherein the one or more local LSP updates are generated by the active IS-IS process responsive to configuration data inputs provided by one or more sub-systems operating in association with the active IS-IS process.

19. The non-transitory computer-readable medium as recited in claim 17, wherein the first link state database associated with the active IS-IS process and the second link state base associated with the standby IS-IS process each comprises a Level 1 (L1) link state database.

20. The non-transitory computer-readable medium as recited in claim 17, wherein the first link state database associated with the active IS-IS process and the second link state base associated with the standby IS-IS process each comprises a Level 2 (L2) link state database.

21. The non-transitory computer-readable medium as recited in claim 17, wherein the active IS-IS process is configured to transmit the one or more local LSP updates to each adjacent IS-IS router.

22. The non-transitory computer-readable medium as recited in claim 17, wherein the standby IS-IS process is configured to generate one or more local LSP updates responsive to configuration data inputs provided by one or more sub-systems operating in association with the standby IS-IS process and to update the second local LSP database portion of the second link state database based on the one or more local LSP updates generated by the standby IS-IS process.

23. The non-transitory computer-readable medium as recited in claim 17, further comprising computer instructions configured to perform:
activating the standby IS-IS process as a new active IS-IS process pursuant to a switchover condition;
validating a synchronized local LSP of the second local LSP database portion of the second link state database based on (i) generating a new local LSP copy using internal data collected by the new active IS-IS process, (ii) generating a checksum for the synchronized local LSP and a checksum for the new local LSP copy, and (iii) comparing the checksums of the synchronized local LSP and the new local LSP copy; and
if the checksums are not identical, updating the synchronized local LSP and flooding the updated synchronized local LSP to each adjacent IS-IS router coupled to the IS-IS router.

24. The non-transitory computer-readable medium as recited in claim 23, further comprising computer instructions configured to perform:
if the checksums are identical, discarding the new local LSP copy and retaining the synchronized local LSP for use by the IS-IS router.
